(19) United States
(12) Patent Application Publication
(10) Pub. No.: US 2021/0301475 A1
(43) Pub. Date: Sep. 30, 2021

(54) POLYMERIC FOAM MATERIAL FOR SHOCK PADS IN ARTIFICIAL GRASS SYSTEMS

(71) Applicant: INNOGRAAF B.V., Wijchen (NL)

(72) Inventor: Jan Noordegraaf, Wijchen (NL)

(21) Appl. No.: 17/214,387

(22) Filed: Mar. 26, 2021

(30) Foreign Application Priority Data
Mar. 27, 2020 (NL) 2025222

(51) Int. Cl. E01C 13/08; C08J 9/228; C08L 23/06

(52) U.S. Cl. CPC E01C 13/08; C08J 9/228; C08L 23/06; C08J 2323/16; C08L 2205/025; C08J 2205/10; C08L 2203/14; C08L 2207/066; C08L 2207/062; C08J 2207/00

(57) ABSTRACT

The present disclosure relates to a shock pad for artificial turf systems, wherein said shock pad comprises low density expanded polyethylene (EPE). An object of the present disclosure is to provide a shock pad providing improved shock absorption and/or energy restitution characteristics to artificial turf systems. Another object of the present disclosure is to provide artificial turf systems having improved shock absorption and/or energy restitution characteristics, especially over a prolonged period of time.

### CROSS-REFERENCE TO RELATED APPLICATION

This application claims the benefit of Dutch Patent Application Serial No. 202522 filed Mar. 27, 2020. The related application is incorporated herein in its entirety by reference.

### BACKGROUND

Natural grass often does not grow long enough in the season, or is used too intensively, and in such a situation an artificial grass solution must often be used. An artificial grass system solution then consists of several components: polymer grass fibres, a base tufting mat, infill, a shock pad, and a sandy surface.

Shock-absorbing pads are usually made of foamed elastomer which provides good energy absorption at a reasonable cost. Such foamed elastomeric material may include polyvinyl chloride, polyethylene, polyurethane or combinations of these and other materials, for instance such as polyvinyl chloride-nitrile rubber or reconstituted rubber. Important criteria in selecting a shock-absorbing pad material include resistance to absorbing water, tensile strength and elongation, open cell versus close cell construction, resistance to chemical attack, low cost, availability in continuous lengths, softness in energy absorbing properties and compression set resistance.

An artificial grass mat is actually much like a carpet mat, which consists of a woven or non-woven backing mat, where short and long fibres of a polymer have been tufted. Whilst 3G turf products can vary in terms of their design and manufacture, they generally all share common components. The turf pile itself is usually made from polyethylene (PE) with a primary backing material of polypropylene (PP) that provides the structure and spacing that the pile is woven into. A secondary backing of a liquid polyurethane (PU) or latex is applied and allowed to set in order to bind the pile to the backing. A so-called infill material is often added between the fibres, which very often consists of cork, wood chips, sand, or ground car tires. In recent years there have also been other more technical polymers that are used as infill, even biodegradable polymers can be used. A stabilizing infill is used to keep the PE fibres vertical during use, and a performance infill provides the correct level of impact resistance to reduce injuries and provide a similar feeling to natural grass. Very often a so-called shock pad is placed under the artificial turf, in which holes have been made that can cause a drainage of the sports field. The use of such a shock pad underneath the mat reduces the amount of performance infill. An average artificial turf pitch of 106×71 meters with styrene-butadiene rubber (SBR) infill (the most common infill type) weights around 36 kg per square meter. This means that the total pitch weighs around 274 tonnes, wherein around half of this is the sand stabilizing infill and 44% is the SBR infill. The remainder is the plastic-based turf itself.

The environmental impacts of these components are therefore often dominated by the infill material. Similarly, the use of a shock pad can reduce the need for infill material and therefore, also has a large bearing on the environmental impact of the turf system. A shock pad can also be used to either provide more shock resistance or to reduce the need for infill. In practice just under two thirds of installations do not utilize a shock pad, with the remaining mainly comprised of polyethylene (PE) or a blend of recycled SBR bound and polyurethane (PU). SBR installations generally tend not to include a shock pad since the costs of incorporating a sufficiently thick layer of infill to provide this function are relatively low for SBR. EPDM and TPE installations are more likely to include a shock pad, partly due to the higher cost of these materials. By introducing a shock pad the infill density can be reduced whilst retaining similar performance characteristics. The installation of a shock pad can greatly reduce the environmental impact when used alongside virgin polymer infills due to the reduction in the need for infill by 50-60%. Where a shock pad is used, it is very environmentally beneficial to leave it in place for reuse when a new turf is installed. Reusing it need not impact performance quality of the pitch.

The so-called shock pad consists of a foamed polyolefin polymer or foamed polyolefin polymer beads that are glued together. A polyolefin is a type of polymer produced from a simple olefin (also called an alkene with the general formula CnH2n) as a monomer. Examples of thermoplastic polyolefins are polyethylene (PE) and polypropylene (PP).

International application WO2013/060634 relates to a shock pad for artificial turf systems. Such a shock pad is a three-dimensional entangled mat of extruded filaments made from a thermoplastic elastomeric polymer, namely a thermoplastic polyurethane elastomeric polymer, wherein the thermoplastic polyurethane elastomeric polymer is a polyether-based thermoplastic polyurethane elastomeric polymer.

European application EP 0 424 080 relates to a shock absorbing pad structure for athletic equipment comprising a flexible enclosure having a cavity and a flexible foam member disposed within the cavity, the foam member having an undulated configuration formed by a plurality of elevations and depressions arranged in an alternating, staggered relationship with respect to one another, the foam member being an open-cell foam material, such as a polyolefin foam, such as polyurethane foam.

European application EP 0 168 545 relates to an artificial turf assembly comprising a layer of artificial turf bonded to a unitary, shock-absorbing, polymeric pad having a vertically asymmetric compression resistance, said pad having an upper layer and a lower layer, wherein said upper layer comprises a polymer selected from the group consisting of polyvinyl chloride, a polyvinyl chloride-nitrile rubber and a reconstituted rubber, and wherein said lower layer comprises a polymer which is the same as the upper layer or polyethylene or polypropylene.

US patent application US2020063379 relates to a turf underlayment layer for supporting an artificial turf assembly, the turf underlayment layer comprising a plurality of panels assembled together, the panels being made from a plurality of polyolefin beads bonded together by at least one of pressure and heat to produce a substantially water-impervious surface.

International application WO2005019533 relates to a multi-layered sports playing field for use over a base layer, said playing field including a top layer made of substantially artificial material simulating a natural playing surface such as grass and at least one padding layer positionable thereunder between said top layer and said base layer, said padding layer being porous and breathable to allow liquids and air to freely pass therethrough, said padding layer including a plurality of discrete beads of substantially elastic, resilient material wherein portions of adjacent beads abut one another and other portions of said adjacent beads are spaced from each other to create interstitial spaces therebetween and wherein substantially all of said adjacent beads are integrally joined together at the abutting portions thereof. The beads are made of foam, i.e. a closed cell foam, for example polypropylene or polyethylene.

US patent application US2018355561 relates to an impact absorption panel, the panels being made from a plurality of polyolefin beads, i.e. polypropylene, the plurality of polyolefin beads bonded together by at least one of pressure and heat to produce a substantially water-impervious surface.

Substructures for a sports field have been disclosed in, inter alia, French patent publication FR 2 395 357, US patent application US 2004/086664, German Offenlegungsschrift DE 38 35 880, European application EP 1 428 935, International application WO2006007862, U.S. Pat. No. 5,104,712.

To make a foamed product for an underlay in a sports field, there are a limited number of production methods, i.e. blown sheet, glued sheet matt and particle foamed sheet or shock pad systems.

It appears that the use of a polymer foam used in shock pads is limited to a few specific polymer applications, the table below give some examples and also where it is not used.

TABLE 1
Polymer foam used in shock pads

| polymer and | directly extruded | particle foam | foam waste |
|---|---|---|---|
| process | foamed sheet | moulded to sheet | pressed sheet |
| PE polymer | Sekisui cross linked | does not exist for | SCHMITZ |
| | PE 120-200 kg/m3 | Shock pads | FOAM 120- |
| | | | 150 kg/m3 |
| PP polymer | Sekisui cross linked | Saltex EPP | does not |
| | PE 120-200 kg/m3 | Probase industry | exist |
| | | standard 40-60 | |
| | | kg/m3 | |

TABLE 2
Main features in shock pads

| | Sekisui cross | Saltex EPP | |
|---|---|---|---|
| | linked | Probase industry | SCHMITZ |
| | PE and PP | standard 40-60 | FOAM 120- |
| main features | 120-200 kg/m3 | kg/m3 | 150 kg/m3 |
| shock property | Too soft | represents the | does not always |
| | for shock | industry standard, | return to original |
| | pads, too high | considered | position, |
| | HIC value | to be a bit stiff | inhomogeneous |
| Environmental | No issues | No issues | Leaches |
| | | represents | heavy metals, |
| | | the industry | varying |
| | | standard | composition |
| water | slits cut in the | designed-in | porous through its |
| drainage by | foamed sheet | moulded | manufacturing |
| | | openings | process |

Foams having cushioning action will now be discussed.

Since polyethylene foam is very difficult to foam, a so-called cross linking of the polymer is often used. Taiwanese patent application TW201941930 discloses a method for manufacturing a polyethylene resin extruded foam sheet having excellent compression properties and an excellent surface state while suppressing generation of wrinkle. US patent application US2011272620 relates to a process comprising physical foaming a master batch comprising: a nucleating organic compound which, on changing to the solid phase, forms crystals and which in its melt phase is soluble in the molten polyethylene and polyethylene. Japanese patent application JPH0543731 relates to a method for manufacturing a cross-linked moulded product by moulding 90 to 40 parts by weight of polyethylene having a density of 0.926 g/cm3 or more, 10 to 60 parts by weight of linear low density polyethylene (L-LDPE) having a density of 0.918 to 0.940 g/cm3, and a pyrolytic foaming agent, irradiating the composition with ionizing radiation, and then subjecting the composition to heat foaming Japanese patent application JPH07258445 relates to a method for producing a crosslinked polyolefin-based resin foam, comprising: forming a foamable moulded body by melt-kneading at a temperature; irradiating the mixed resin composed of 40 to 80% by weight of a polypropylene resin, 15 to 55% by weight of a polyethylene resin and 5 to 45% by weight of a polybutene resin, with ionizing radiation to crosslink the resin.

Japanese patent application JP2019183121 relates to composite resin particles for foaming containing a polyethylene resin, an ethylene copolymer, and a polystyrene resin in a mass ratio of the total amount of the polyethylene resin and the ethylene copolymer/polystyrene resin=5/95 to 35/65, wherein the polyethylene resin is a linear low-density polyethylene.

Japanese patent application JP2016069471 relates to a foamed particle having a core layer made of a mixed resin in a foamed state and a coating layer made of a polyethylene resin (A) that covers the core layer, wherein the mixed resin is made of a polyethylene resin (B) and polystyrene and a compatibilising agent for compatibilising the two, and the mass ratio of the polyethylene resin (B) and the polystyrene resin in the mixed resin (polyethylene resin (B): (Polystyrene resin) is 25:75 to 50:50.

International application WO2008145267 relates to a physically blown polyethylene foam based on a blend comprising 95.5% by weight-99.5% by weight low density polyethylene and 0.5% by weight-4.5% by weight high density polyethylene, a nucleating agent, wherein the nucleating agent is talcum, silica, a mixture of sodium bicarbonate and citric acid, an amide, an amine and/or an ester of a saturated or unsaturated aliphatic (C10-C34) carboxylic acid, and a cell stabilizer, namely glycerol monostearate, glycerol monopalmitate, palmitamide and/or an amide. Such a polyethylene foam is used in the production of films, sheets, profiles, rods, and tubes. The density of the physically blown polyethylene foam ranges between 10 and 400 kg/m3, preferably the density of the foam ranges between 20 and 300 kg/m3.

An object of the present disclosure is to provide a shock pad providing improved shock absorption and/or energy restitution characteristics to artificial turf systems.

Another object of the present disclosure is to provide artificial turf systems having improved shock absorption and/or energy restitution characteristics, especially over a prolonged period of time.

### BRIEF SUMMARY

Disclosed herein is a shock pad for artificial turf systems, wherein said shock pad comprises low density expanded polyethylene (EPE).

The above described and other features are exemplified by the following figures, detailed description, and claims.

### BRIEF DESCRIPTION OF THE DRAWINGS

The following Figures are exemplary embodiments, which are provided to illustrate the present disclosure. The figures are illustrative of the examples, which are not intended to limit devices made in accordance with the disclosure to the materials, conditions, or process parameters set forth herein.

FIG. 1 shows the HIC value (y) according to EN117 as a function of drop height (x).

FIG. 2 shows a front view of components of 3G turf products.

### DETAILED DESCRIPTION

The present disclosure thus relates to a shock pad for artificial turf systems, wherein said shock pad comprises low density expanded polyethylene particle foam (EPE).

One or more of the above discussed objects of the present disclosure is achieved by a shock pad comprising low density expanded polyethylene (EPE). Surprisingly, it has been found that such material provides improved shock absorption and/or energy restitution characteristics.

In an embodiment of the present disclosure the density of the expanded polyethylene (EPE) according to the present disclosure ranges from 10-100 kg/m³.

In another embodiment of the present disclosure the density of the expanded polyethylene (EPE) according to the present disclosure ranges from 15-80 kg/m³.

In an embodiment of the present disclosure the low density expanded polyethylene EPE is made of a blend, on a polymer level, comprising 30-80% by weight of low density polyethylene and 20-70% by weight of high density polyethylene, based on the weight of low density expanded polyethylene EPE. The total sum of components amounts to 100%.

In an embodiment of the present disclosure the blend further comprises 0-30% by weight of one or more polyolefins, especially polypropylene. The total sum of components amounts to 100%.

In an embodiment of the present disclosure the one or more polyolefins is a mechanical mix of several particle foams comprising 5-95% by weight of a polypropylene particle foam and 95-5% by weight of a polyethylene particle foam, based on the total weight of said mix, whereby the sum of the individual quantities together amounts to 100%.

In an embodiment of the present disclosure the shockpad comprises a mix of particle foams, wherein the mix can comprise at least one of EPP, EPS, EPE, ETPU, EPET, EPBAT, EPLA, EPCL, EPHBH, EPHA, EPLA/PBTA blends, EPVC and EPE-PS blend , said mix comprises 5-95% by weight of EPE and 95-5% by weight of a second type of particle foam chosen from said group of particle foams, whereby the sum of the individual quantities together amounts to 100%. In such an embodiment the shockpad comprises a mix of two particle foams, for example 70% by weight of EPE and 30% by weight of EPHA. It is clear that the second type of particle foam is different from EPE in such a mix of particle foams.

In an embodiment of the present disclosure the shockpad comprises a mix of particle foams, wherein the mix can comprise at least one of EPP, EPS, EPE, ETPU, EPET, EPBAT, EPLA, EPCL, EPHBH, EPHA, EPLA/PBTA blends, EPVC and EPE-PS blend, comprising 5-95% by weight of EPE, 95-5% by weight of a second type of particle foam and 20-50% by weight of a third type of particle foam, all types are chosen from said group of particle foams, whereby the sum of the individual quantities together amounts to 100%.%. It is clear that the second type of particle foam is different from both EPE and the third type of particle foam in such a mix of particle foams. It is also clear that the third type of particle foam is different from both EPE and the second type of particle foam in such a mix of particle foams. In such an embodiment the shockpad comprises a mix of three particle foams, for example 70% by weight of EPE, 20% by weight of EPET and 10% by weight of EPP.

The present disclosure furthermore relates to an artificial turf system, i.e. a multi-layered sports playing field, comprising at least a shock pad as discussed above. In such an artificial turf system a part of the substructure comprises at least a shock pad as discussed above.

The present disclosure furthermore relates to a playground system, i.e. a multi-layered playground system, comprising at least a shock pad as discussed above. In such a playground system a part of the substructure comprises at least a shock pad as discussed above.

The shock pad may be used as a shock pad under several kinds of playing fields, such as for example rugby pitches, tennis courts, hockey fields, indoor and outdoor playing fields, such as for example volleyball, handball, basketball, gymnastics, indoor and outdoor soccer pitches, children play grounds and running tracks.

The shock pad according to the present disclosure further provides a high capacity for drainage of liquid, for example (rain) water, from the artificial turf playing field due to its open three-dimensional structure. The drainage may include both vertical and horizontal drainage capabilities. The shockpad may also comprise one or more additional layers, such as a film, being pervious or impervious to liquid, a layer of fibrous material, such as a woven or a nonwoven, a two-dimensional grid or scrim, or a three-dimensional entangled mat of extruded filaments.

The present inventor made a comparison between commercially available shock pads material and the low density expanded polyethylene (EPE) according to the present disclosure. In Table 3 (see below) some parameters have been listed for both commercially available shock pads material and low density expanded polyethylene (EPE) according to the present disclosure. Reference materials shown in Table 3 are Expanded polypropylene particle foam (EPP), recycled ground crosslinked XPE and a possible expanded ETPU foam.

TABLE 3
Comparison between commercially available shock pads material and
low density expanded polyethylene (EPE).

| | | E, Young's | | | relative |
|---|---|---|---|---|---|
| | | Modulus | | | E |
| | Young's | used for | | used | for |
| | Modulus | calculation, | kg/m3 | thickness, | density |
| material | MPa | MPa | density | m | MPa /m3 |
| Polypropylene, | 1500-2000 | 1750 | 37.8 | 0.0234 | 66.15 |
| EPP | | | | | |
| Pro Base 23 | | | | | |
| Polyethylene, | 110-450 | 230 | 160 | 0.023 | 36.8 |
| recycle PRO | | | | | |
| play 2 | | | | | |
| Schmitz | | | | | |
| TPU type | 800 | 800 | 180 | 0.023 | 144 |
| medium | | | | | |
| stiffness | | | | | |
| Polyethylene, | 110-450 | 500 | 20 | 0.023 | 10 |
| EPE | | | | | |
| target | | | | | |

Since recycled XPE cross linked foam and EPP particle foam are used as shock pad materials, the given density can be related to the Young's modulus of the base polymer used. A comparative relative E (Young's modulus) can be calculated, MPa/m³, corrected for the foam density.

ETPU foam could also be envisaged, and is available, but the foam density is higher than for EEP and also its relative price is higher, so although technically feasible, it would not become an economic viable alternative.

Hereinafter, the present disclosure will be described with reference to the accompanying drawings. However, it should be understood that the disclosure can be embodied in various forms and thus is not limited to the embodiments described herein. In addition, in order to clearly describe the disclosure, parts irrelevant to the description of the disclosure are omitted in the drawings, and like reference numerals designate like parts throughout the specification.

Hereinafter, Examples of the present disclosure will be described in detail.

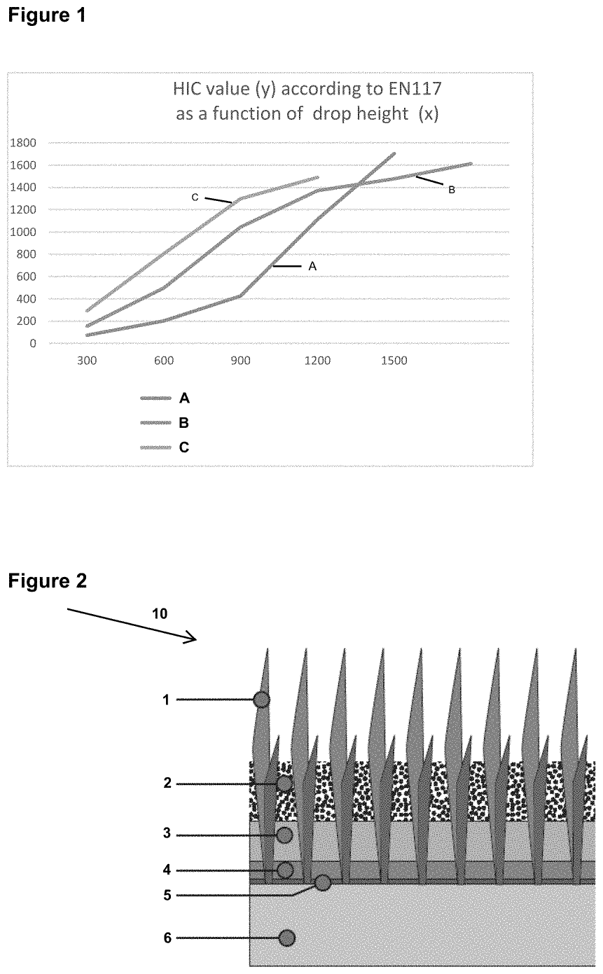

FIG. 1 shows the HIC value (y) according to EN117 as a function of drop height (x).

FIG. 2 shows a front view of components of 3G turf products.

Whilst 3G turf products 10 can vary in terms of their design and manufacture, they generally all share common components (see FIG. 2). The turf pile 1 itself is usually made from polyethylene (PE) with a primary backing material 4 of polypropylene (PP) that provides the structure and spacing that the pile 1 is woven into. A secondary backing 5 of a liquid polyurethane (PU) or latex is applied and allowed to set in order to bind the pile 1 to the backing 4. A stabilizing infill 3 is used to keep the PE fibres 1 vertical during use, and a performance infill 2 provides the correct level of impact resistance to reduce injuries and provide a similar feeling to natural grass. In some cases, there is also a shock pad 6 underneath which reduces the amount of performance infill 2. It is to be noted that such a turf product 10 is not restricted to the type of materials mentioned above. In some embodiments of a turf product additional layers beneath the shock pad, or additional layers between the secondary backing 5 and shock pad 6 are present. However, the present disclosure is not restricted to the specific construction and materials shown in FIG. 2. Shock pads are 10-50 mm thick, often 22 mm is used, but for particle foam also much thicker up to 50 mm can be used.

The following examples are provided to illustrate the present disclosure. The examples are merely illustrative and are not intended to limit devices made in accordance with the disclosure to the materials, conditions, or process parameters set forth therein.

### EXAMPLE

A one step expanded PE based particle foam was obtained using a blend of 70% LDPE and 30% HDPE in a single screw extrude equipped with a 2nd stage melt cooling to which 7-10% CO₂ was added and extruded through a die face cutter, producing an expanded foam with a density of 12-15 gr/l. The following materials were used. LDPE being ExxonMobil™ LDPE LD 100. BW with an MFI of 2 g/10 measured according to ISO 1133 at 2.16 kg/190° C. and HDPE Relene type 1020FA20 with an MFI of 2 g/10 min from Reliance Industries Mumbai, India, measured according to ISO 1133 at 2.16 kg 190° C. The 15 gr/1 foam had to be moulded using a compression step during moulding towards 20 gr/l. With steam pressure of 3-4 bars and a pre-impregnated air pressure, a sheet with a thickness of 2 cm and a density of 20 gr/l was thus obtained and compared to existing materials.

Testing points; point elastic vs volume elastic

Two factors are important. The relative Young's modulus gives an information about a point elastic property, important for ball bounce. In relation to preventing personal injury, a volume elastic property like the HIC value is used as a predictive parameter. The HIC test device is used worldwide in laboratories, by manufacturers and experts for the testing of protection mats or other damping materials (e.g. on playgrounds) The Head Injury Criterion (HIC) as measured according standard EN 1177 is a measure of the likelihood of head injury arising from an impact. The HIC can be used to assess safety related to vehicles, personal protective gear, and sport equipment. As each impact may damage the plate a new area of the plate shall be impacted for each drop. Tests shall be made at a range of drop heights starting at 300 mm and increasing in 300 mm increments until the HIC value exceeds 1500 or a height of 2000 mm is achieved, whichever occurs sooner.

Crosslinked XPE sheet is not used as it has a too high shock force reduction/elasticity. The ball will not bounce back properly. The new EPE foam with the low density appears to be more volume elastic than EPP and more elastic than the recycled crosslinked higher-density PE foam. FIG. 1 shows the HIC value (y) according to EN117 as a function of drop height (x). In FIG. 1 the “A” refers to polypropylene, EPP Pro Base 23, “B” to polyethylene, recycle Pro play 20 Schmitz and “C” to polyethylene, EPE according to the present disclosure.

The point elastic properties can be quantified using the EN15330-1 standard as referred to in the ESTO performance guide (European Synthetic Turf Organization). Several commercial materials were tested and compared to the obtained sheet of the EPE particle foam product according to the present disclosure and shown in Table 4.

TABLE 4
Comparison between commercial materials and EPE particle foam
product according to the present disclosure.
Conformity to EN 15330-1
Test conditions: ESTO Performance Guide
for Shockpads except for test with load
spreading plate

| | | | results | | |
|---|---|---|---|---|---|
| | | | | Shock | |
| | | sheet | | force | |
| | density | tickness, | impression | reduction | pass/ |
| shockpad material | kg/m3 | mm | mm | FR % | fail |
| Polypropylene, EPP | 38 | 23 | 8.8 | 69.1 | pass |
| Pro Base 23 | | | | | |
| Polyethylene, recycle | 150 | 20 | 5 | 60.6 | pass |
| PRO play 20 Schmitz | | | | | |
| EPE particle foam, | 25 | 20 | 10 | 65 | pass |
| present invention | | | | | |
| 50/50 blend of | 39 | 23 | 9.4 | 67 | pass |
| EPP Eperan M45 | | | | | |
| particle foam and | | | | | |
| EPE particle foam | | | | | |
| present invention | | | | | |
| XPE sheet Sekisui | 300 | 10 | 6.8 | 80.5 | nr |
| XPE sheet Sekisui | 250 | 12 | 7.4 | 84 | nr |
| XPE sheet Sekisui | 416 | 12 | 8 | 71.7 | nr |
| XPE sheet Sekisui | 357 | 14 | 8.5 | 48.5 | nr |

nr not relevant

The results shown in Table 4 clearly indicate that the impression value of the EPE low density particle foam sheet according to the present disclosure is positioned between that of EPP particle foam and recycled crosslinked XPE. This means that with much reduced density, properties are surprisingly positioned between the existing and most used materials.

Without being bound to any theory, it is believed that the compressed and glued mix of crosslinked XPE waste is less of a homogenous material as the uniformly moulded EPE particle foam according to the present disclosure. Moreover, the cell wall forms a rigid honeycomb structure, which may give the foam another behaviour than non-cross linked foams. The intrinsic deformation of the polymer chain is altered by crosslinking with is not the case with a not cross-linked foam of the present disclosure.

Moreover, with the present disclosure it is now possible to prepare a deliberate mix of pre-expanded particle foams and to mould a shock pad from these materials. Table 4 also shows an example of a shock pad material that is made with 50% (m/m) Kaneka Eperan type M45 18 gr/l together with 50% (m/m) of EPE at 20 gr/l of the present disclosure. This mix of EPE and EPP particle foam shock pad was compression moulded to a density of 25 gr/, allowing to demonstrate that it is possible to produce a controlled blend of properties of the individual materials.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named.

The term “or” means “and/or” unless clearly indicated otherwise by context. Reference throughout the specification to “an embodiment”, “another embodiment”, “some embodiment”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

The endpoints of all ranges directed to the same component or property are inclusive of the endpoints, are independently combinable, and include all intermediate points and ranges. For example, ranges of “up to 25% by weight, or 5 to 20% by weight” is inclusive of the endpoints and all intermediate values of the ranges of “5 to 25% by weight,” such as 10 to 23% by weight, etc.

Unless defined otherwise, technical and scientific terms used herein have the same meaning as is commonly understood by one of skill in the art to which this disclosure belongs.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A shock pad for artificial turf systems, wherein said shock pad comprises low density expanded polyethylene particle foam (EPE).

2. The shock pad for artificial turf systems according to claim 1, wherein said low density of expanded polyethylene (EPE) ranges from 10-100 kg/m³.

3. The shock pad for artificial turf systems according to claim 2, wherein said low density of expanded polyethylene (EPE) ranges from 15-80 kg/m³.

4. The shock pad for artificial turf systems according to claim 1, wherein said low density expanded polyethylene EPE is made of a blend, on a polymer level, comprising 30-80% by weight of low density polyethylene and 20-70% by weight of high density polyethylene, based on the weight of low density expanded polyethylene EPE.

5. The shock pad for artificial turf systems according to claim 4, wherein said shock pad further comprises 0-30% by weight of one or more polyolefins, wherein the total sum of components amounts to 100%.

6. The shock pad for artificial turf systems according to claim 5, wherein said polyolefins is a mechanical mix of several particle foams comprising 5-95% by weight of a polypropylene particle foam and 95-5% by weight of a polyethylene particle foam, based on the total weight of said mix, whereby the sum of the individual quantities together amounts to 100%.

7. The shock pad for artificial turf systems according to claim 1, wherein said shockpad comprises of a mix of particle foams comprising at least one of EPP, EPS, EPE, ETPU, EPET, EPBAT, EPLA, EPCL, EPHBH, EPHA, EPLA/PBTA blends, EPVC and EPE/PS blend, said mix comprises 5-95% by weight of EPE and 95-5% by weight of a second type of particle foam chosen from said group of particle foams, the second type is different from EPE, whereby the sum of the individual quantities together amounts to 100%.

8. The shock pad for artificial turf systems according to claim 1, wherein said shock pad comprises of a mix of particle foams comprising at least one of EPP, EPS, EPE, ETPU, EPET, EPBAT, EPLA, EPCL, EPHBH, EPHA, EPLA/PBTA blends, EPVC and EPE/PS blend, comprising 5-95% by weight of EPE, 95-5% by weight of a second type of particle foam and 20-50% by weight of a third type of particle foam that is different from EPE and the second type, all types are chosen from said group of particle foams, whereby the sum of the individual quantities together amounts to 100%.

9. An artificial turf system comprising at least a shock pad according to claim 1.

10. A playground system comprising at least a shock pad according to claim 1.
